(19) United States
(12) Patent Application Publication
(10) Pub. No.: US 2003/0054940 A1
(43) Pub. Date: Mar. 20, 2003

(54) Sintered body

(75) Inventors: Yoshihiko Abe, Nagano (JP); Taishu Yanagisawa, Nagano (JP); Masao Fujimori, Nagano (JP); Kousuke Shioi, Nagano (JP)

Correspondence Address: SUGHRUE MION, PLLC, 2100 PENNSYLVANIA AVENUE, N.W., WASHINGTON, DC, 20037, US

(73) Assignee: Showa Denko Kabushiki Kaisha

(21) Appl. No.: 10/058,127

(22) Filed: Jan. 29, 2002

Related U.S. Application Data
(60) Provisional application No. 60/267,178, filed on Feb. 8, 2001.

(30) Foreign Application Priority Data
Jan. 30, 2001 (JP) P2001-021790

(51) Int. Cl. C04B 35/583; C04B 35/56

(52) U.S. Cl. 501/96.4; 501/92; 501/89

(57) ABSTRACT

By providing a cBN sintered body which containing, as a binder, at least one species selected from among nitrides, carbides, carbide nitrides, and borides of a Group IVa, Group Va, or Group VIa; and a boride containing a Group VIII element, and a Group IVa element, Group Va element, or Group VIa element; or when containing, as a binder, at least one species selected from among nitrides, carbides, carbide nitrides, and borides of a Group IVa, Group Va, or Group VIa element; a boride containing a Group VIII element, and a Group IVa element, Group Va element, or Group VIa element; and an Al compound, there can be provided a cBN sintered body which attain lower reactivity with a material to be cut while maintaining excellent ability to retain cBN grains.

### CROSS REFERENCE TO RELATED APPLICATIONS

The present application is filed under 35 U.S.C. §111(a), and claims benefit, pursuant to 35 U.S.C. §119(e)(1), of the filing dates of Provisional Application No. 60/267,178 filed Feb. 8, 2001, pursuant to 35 U.S.C. §111(b).

### FIELD OF THE INVENTION

The present invention relates to a sintered product which is endowed with high hardness and excellent wear resistance and is useful as wear resistant material for fabricating cutting tools, bearings, wire-drawing dies, etc.

### BACKGROUND OF THE INVENTION

Conventionally, tungsten carbide (WC)-based superhard materials have been employed as wear resistant materials for fabricating cutting tools and similar tools. However, these WC-based superhard materials encounter difficulty in satisfying users' demands, since the demands are becoming increasingly stringent. Thus, development of wear resistant materials of more excellent properties is desired.

Wear resistant materials which meet the above demands have already been proposed; for example, there have been proposed a sintered product of cubic boron nitride (hereinafter referred to as cBN) powder to which a metallic phase containing a small amount of Al and at least one alloying element selected from among the group consisting of Ni, Co, Mn, Fe, and V is incorporated (Japanese Patent Application Laid-Open (kokal) No. 48-17503) and a cBN sintered product obtained by use of a ceramic binder (Japanese Patent Publication (kokoku) No. 57-3631).

In recent years, performance of cutting machines has been remarkably enhanced, and cutting speed is prone to increase more and more so as to meet a demand for energy conservation. Thus, even when a cutting tool made of any of the aforementioned cBN sintered products is employed in high-speed cutting of, for example, cast iron, wear resistance of the tool deteriorates, to thereby problematically shorten the service life thereof.

The cBN sintered products disclosed in the above Japanese Patent Application Laid-Open (kokai) No. 48-17503 or Japanese Patent Publication (kokoku) No. 57-3631 cannot attain sufficient wear resistance during cutting of cast iron under high-speed conditions. A conceivable reason for the former case is as follows. The temperature of the cutting edge is elevated by cutting heat generated under high-speed cutting conditions. Although the heat causes cBN grains to be firmly retained in the sintered product to thereby promote densification of the product, reaction occurs between a material to be cut and a binder formed of an alloying element such as Ni, Co, Fe, Mn, or V, which are highly reactive with the material to be cut, to thereby deteriorate wear resistance. In contrast, as in the latter case, when TiN or similar ceramic which is less reactive with a material to be cut and which has poor ability to retain cBN grains is employed as a binder, falling of cBN grains easily occurs. In addition, the cBN content generally cannot be increased to a high level, due to difficulty in densification of the sintered product. Thus, sufficient wear resistance cannot be attained.

### SUMMARY OF THE INVENTION

In view of the foregoing, the present inventors have conducted earnest studies, and have found that a cBN sintered product can attain lower reactivity with a material to be cut while maintaining excellent ability to retain cBN grains, when containing, as a binder, at least one species selected from among nitrides, carbides, carbide nitrides, and borides of a Group IVa, Group Va, or Group VIa; and a boride containing a Group VIII element, and a Group IVa element, Group Va element, or Group VIa element; or when containing, as a binder, at least one species selected from among nitrides, carbides, carbide nitrides, and borides of a Group IVa, Group Va, or Group VIa element; a boride containing a Group VIII element, and a Group IVa element, Group Va element, or Group VIa element; and an Al compound. The inventors have also found that heat resistance and thermal conductivity of the aforementioned binder can be enhanced, to thereby synergistically further improve wear resistance of a cutting tip of a tool that is subjected to high temperature conditions during high-speed cutting. The inventors have also found that the sintered product can be cut by means of a wire electric discharge machine, thereby attaining easy processability after sintering. The present invention has been accomplished on the basis of these findings.

Accordingly, the present invention provides the following:

[1] A sintered product containing cubic boron nitride and a binder, characterized in that the binder contains at least one species selected from among nitrides, carbides, carbide nitrides, and borides of a Group IVa, Group Va, or Group VIa element; and a boride containing a Group VIII element, and a Group IVa, Group Va, or Group VIa element.

[2] A sintered product containing cubic boron nitride and a binder, characterized in that the binder contains at least one species selected from among nitrides, carbides, is carbide nitrides, and borides of a Group IVa, Group Va, or Group VIa element; a boride containing a Group VIII element, and a Group IVa, Group Va, or Group VIa element; and an Al compound.

[3] A sintered product as described in [1] or [2], wherein the nitrides, carbides, carbide nitrides, and borides of a Group IVa, Group Va, or Group VIa element are TiN, TiC, TiCₓN₁₋ₓ (0<x<1), TiB₂, WC, WB, and W₂B.

[4] A sintered product as described in any one of [1] to [3], wherein the boride containing a Group VIII element, and a Group IVa, Group Va, or Group VIa element is WCoB, W₂Co₂₁B₆, W₃CoB₃, or W₂CoB₂.

[5] A sintered product as described in any one of [2] to [4], wherein the Al compound is AlN or AlB₂.

[6] A sintered product as described in any one of [1] to [3], wherein the sintered product contains cubic boron nitride in an amount falling within a range of 50-95 area % and the binder contains species selected from among nitrides, carbides, carbide nitrides, and borides of a Group IVa, Group Va, or Group VIa element in a total amount falling within a range of 58-98 area % based on the entirety of the binder, and the boride containing a Group VIII element, and a Group IVa, Group Va, or Group VIa element in an amount falling within a range of 2-42 area %.

[7] A sintered product as described in [2] or [3), wherein the sintered product contains cubic boron nitride in an amount falling within a range of 50-95 area %, and the binder contains species selected from among nitrides, carbides, carbide nitrides, and borides of a Group IVa, Group Va, or Group VIa element in a total amount falling within a range of 36-78 area % based on the entirety of the binder; the boride containing a Group VIII element, and a Group IVa, Group Va, or Group VIa element in an amount falling within a range of 2-43 area %; and the Al compound in an amount falling within a range of 16-33 area %.

[8] A cutting tool employing a sintered product described in any one of [1] to [3].

### DETAILED DESCRIPTION OF THE INVENTION

Examples of nitrides, carbides, carbide nitrides, borides of a Group IVa, Group Va, or Group VIa element, serving as binder components incorporated in the sintered product of the present invention include TiC, TiB₂, Ti₂B₅, Ti₃B₄, TiB, TiN, Ti₂N, TiCₓN₁₋ₓ (0<×<1), ZrC, ZrB₂, ZrB₁₂, ZrN, ZrCₓN₁₋ₓ (0<x<1), HfC, HfB₂, HfB, HfB₁₂, Hf₃N₂, HfN, Hf₄N₃, HfCₓN₁₋ₓ (0<x<1), VC, V₄C₃, V₈C₇, VB₂, V₃B₄, V₃B₁₂, VB, V₅B₆, V₂B₂, VN, V₂N, VCₓN₁₋ₓ (0<x<1), NbC, Nb₆C₅, Nb₂C, NbB₂, Nb₃B₂, NbB, NbN, Nb₄N₃, Nb₂N, NbCₓN₁₋ₓ (0<x<1), TaC, Ta₂C, TaB₂, Ta₂B, Ta₃B₂, TaB, Ta₃B₄, TaN, Ta₃N₅, Ta₄N, Ta₂N, TaCₓN₁₋ₓ (0<x<1), Cr₃C₂, Cr₂C, Cr₂₃C₆, Cr₇C₃, CrB, CrB₄, Cr₂B, Cr₂B₃, Cr₅B₃, CrB₂, Cr₂N, Mo₂C, MoC, MoB, Mo₂B₅, MoB₄, MO₂B, MoB₂, WC, W₂C, WB, W₂B, WB₄, WN, W₂N, a solid solution thereof, a multi-component compound thereof, and a compound thereof having an unspecific composition. Of these, TiN, TiC, TiCₓN₁₋ₓ (0<x<1), TiB₂, WC, WB, and W₂B are particularly preferred.

The boride containing a Group VIII element, and a Group IVa, Group Va, or Group VIa element refers to a compound represented by M_{Ix}M_{IIy}B_{z} (M_{I}: Group IVa, Group Va, or Group VIa element; M_{II}: Group VIII element; x, y, z>0) and including a solid solution thereof and a compound thereof having an unspecific composition. Examples include W₂FeB, WFeB, MoFe₂B₄, MO₂Fe₁₃B₅, MoFe₂B₄, Mo₂FeB₂, TaNiB₂, HfCo₃B₂, MoCoB, Mo₂CoB₂MoCo₂B₄, NbCoB₂, NbCoB, Nb₃Co₄B₇, Nb₂Co₃B₅, W₃CoB₃, WCoB, W₂CoB₂, and W₂Co₂₁B₆. Of these, WCOB, W₂Co₂₁B₆, W₃CoB₃, and W₂CoB₂ are particularly preferred.

Examples of the Al compound include AlB₁₂, AlB₁₀, AlB₂, Al₃B₄₈C₂, Al₈B₄C₇, AlB₁₂C₂, and AlN. Of these, AlN and AlB₂ being particularly preferred.

When a nitride, a carbide, a carbide nitride, and/or a boride of a Group IVa, Group Va, or Group VIa element is incorporated into a binder for producing a cBN sintered product, reactivity of the sintered product with a material to be cut can be reduced, and hardness of the binder itself can be increased. When a boride containing a Group VIII element, and a Group IVa, Group Va, or Group VIa element is incorporated into a binder for producing a cBN sintered product, mechanical strength and toughness of the sintered product can be increased; densification of the sintered product can be enhanced; reactivity of the sintered product with a material to be cut can be reduced; and wear resistance under high-speed cutting conditions can be increased. When an Al compound is added to the binder, heat resistance, thermal conductivity, etc. of the binder can be enhanced, to thereby further improve characteristics of the cBN sintered product.

The sintered product of the present invention contains cBN preferably in an amount of 50-95 area %, more preferably 55-95 area %, most preferably 60-95 area %, and the balance is preferably a binder.

As used herein, the term “area %” refers to a percent area of a relevant component contained in a composition as observed on a polished surface of a portion of the sintered product. Although the area % may be determined by means of a metallographical microscope or a similar apparatus, cBN content and crystal composition of a binder is generally measured by means of an X-ray diffraction apparatus, an electron beam microanalyzer, and an image graphic analyzer.

When the cBN content is less than 50 area %, hardness and thermal conductivity sufficient for use in high-speed cutting cannot be attained, whereas when the cBN content is in excess of 95%, attaining densification of the sintered product disadvantageously requires high sintering temperature and pressure. The cBN powder to be used suitably has an average particle size falling within a range of 6-0.1 μm, preferably 3-0.1 μm.

The binder contains species selected from among nitrides, carbides, carbide nitrides, and borides of a Group IVa, Group Va, or Group VIa element preferably in a total amount falling within a range of 58-98 area %, more preferably 65-98 area %, most preferably 74-98 area %, based on the entirety of the binder. The binder also contains a boride containing a Group VIII element, and a Group IVa, Group Va, or Group VIa element in an amount falling within a range of 2-42 area %, more preferably 2-35 area %, most preferably 2-26 area %, based on the entirety of the binder.

In the case where the binder contains an Al compound, the binder contains species selected from among nitrides, carbides, carbide nitrides, and borides of a Group IVa, Group Va, or Group VIa element preferably in a total amount falling within a range of 36-78 area %, more preferably 40-75 area %, most preferably 50-70 area %. The binder also contains a boride containing a Group VIII element, and a Group IVa, Group Va, or Group VIa element preferably in an amount falling within a range of 2-43 area %, more preferably 2-39 area %, most preferably 2-35 area %. The binder also contains an Al compound preferably in an amount falling within a range of 16-33 area %, more preferably 20-33 area %, most preferably 25-33 area %.

In the case where the binder contains no Al compound, and at least one species selected from among nitrides, carbides, carbide nitrides, and borides of a Group IVa, Group Va, or Group VIa element is contained in an amount less than 58%, effects on reduction of reactivity with a material to be cut and on enhancement of hardness of the binder are insufficient, whereas when the amount is in excess of 98%, toughness of the sintered product is lowered. In addition, when the boride containing a Group VIII element, and a Group IVa, Group Va, or Group VIa element is contained in an amount less than 2%, effects on enhancement of mechanical strength and toughness of the sintered product are insufficient, whereas when the amount is in excess of 42%, hardness of the sintered product decreases; these cases are not preferred.

In the case where the binder contains an Al compound, and at least one species selected from among nitrides, carbides, carbide nitrides, and borides of a Group IVa, Group Va, or Group VIa element is contained in an amount less than 36%, effects on reduction of reactivity with a material to be cut and on enhancement of hardness of the binder are insufficient, whereas when the amount is in excess of 78%, toughness of the sintered product is lowered. In addition, when the boride containing a Group VIII element, and a Group IVa, Group Va, or Group VIa element is contained in an amount less than 2%, effects on enhancement of mechanical strength and toughness of the sintered product are insufficient, whereas when the amount is in excess of 43%, hardness of the sintered product is lowered. When the Al compound content is less than 16%, effects on enhancement of heat resistance and thermal conductivity of the binder are insufficient, whereas when the content is in excess of 33%, hardness of the sintered product is lowered; these cases are not preferred.

In order to obtain the sintered product of the present invention, the following procedure may be followed. Specifically, powder of at least one species selected from among nitrides, carbides, carbide nitrides, and borides of a Group IVa, Group Va, or Group VIa element; powder of a boride containing a Group VIII element, and a Group IVa, Group Va, or Group VIa element; and powder of an optional Al compound are mixed together. The resultant mixture is heated in accordance with needs or is not subjected to heat treatment, and sintered under ultrahigh pressure at high temperature. Both ways may be combined, to thereby obtain the product of the present invention. The sintered product of the present invention can also be produced by use of any combination of powders other than that employed in the above case. In other words, any combination may be employed so long as the CBN sintered product of the present invention containing a binder of a composition and area % falling within a range of the present invention can be produced through heat treatment of the powder mixture and sintering under high pressure.

For example, in the case in which another combination of powders is employed, starting material powders may be of element metals of Group IVa, Group Va, Group VIa, or Group VIII; Al; alloys thereof; intermetallic compounds thereof; boron, carbon, boron carbide, and boron nitride; as well as carbides, nitrides, carbide nitrides, borides, boride nitrides, and boride carbides of Al, those of a Group IVa, Group Va, or Group VIa element, and those of a Group VIII element; a multi-component compound thereof; solid solution thereof; or a compound having an unspecific composition. These powders are mixed together, and the resultant mixture is heated in accordance with needs or is not subjected to heat treatment, and sintered under ultrahigh pressure at high temperature. In this case, cBN powder can serve as a nitrogen source or a boron source for forming a binder.

During production of the sintered product of the present invention, heat treatment is performed preferably in vacuum or a non-oxidizing atmosphere of, for example, N₂ or Ar. In addition, in order to produce the product of the present invention, a pressure of 4.5 GPa or higher and a temperature of 1,400° C. or higher are preferably employed. Sintering must be performed under conditions in which cBN remains stable. If sintering temperature is lower than 1,400° C., obtaining the sintered product of the present invention requires a long period of time. Also, in a production method in which a binder of interest is generated through heating, such a low temperature may lead to insufficient generation of the target binder. Thus, in some cases, residues such as metallic Co generate, to thereby deteriorate wear resistance of the sintered product.

### BEST MODES FOR CARRYING OUT THE INVENTION

### EXAMPLES 1 to 15 AND COMPARATIVE EXAMPLES 1 to 8

As shown in Table 1, CBN powder (av. particle size: 1 μm) and binder components were weighed and mixed to yield raw material powders, and each powder was wet-kneaded for 24 hours by use of a ball mill, to thereby yield a slurry. Acetone (special grade chemical) was used as a solvent for mixing. The slurry was sufficiently dried, and subsequently, the dried matter was introduced in a ultrahigh-pressure sintering apparatus and sintered for one hour under the conditions shown in Table 1, to thereby yield a sintered product (diameter: 29 mm, thickness: 5 mm). The upper surface and bottom surface of the sintered product were ground by use of diamond wheel stone.

TABLE 1

| | | | Sinter- | | | | | | | |
|---|---|---|---|---|---|---|---|---|---|---|
| | | cBN | ing | Crystal compositions (proportions) of binder | | | | | | Width of |
| | Components and compositional | content | temp. | | | | Area % | Area % | Area % | flank |
| | proportions (wt. %) | (area %) | (° C.) | (1) | (2) | (3) | of (1) | of (2) | of (3) | wear (mm) |
| Ex. | cBN(87), Ti₂AlN(8), WC—Co(5) | 90 | 1,500 | TiN, | WCoB, | AlN, | 40% | 39% | 21% | 0.10 |
| 1 | | | | TiB₂, WC | W₂Co₂₁B₆ | AlB₂ | | | | |
| Ex. | cBN(85), Ti₂AlN(11), WC—Co(5) | 85 | 1,500 | TiN, | WCoB, | AlN | 55% | 25% | 20% | 0.12 |
| 2 | | | | TiB₂, WC | W₂Co₂₁B₆ | | | | | |
| Ex. | cBN(85), TiN(5), WC—Co(10) | 85 | 1,500 | TiN, | WCoB, | — | 74% | 26% | — | 0.15 |
| 3 | | | | TiB₂, WC | W₂Co₂₁B₆ | | | | | |
| Ex. | cBN(85), Ti₂AlN(15), WC—Co(10) | 80 | 1,500 | TiN, | W₂CoB₂ | AlN, | 64% | 8% | 28% | 0.11 |
| 4 | | | | TiB₂, WB | | AlB₂ | | | | |
| Ex. | cBN(85), TiN(5), TiC(5), | 80 | 1,500 | TiN, | WCoB | — | 89% | 11% | — | 0.15 |
| 5 | WC—Co(15) | | | TiC, | | | | | | |
| | | | | TiB₂, WB | | | | | | |
| Ex. | cBN(74), Ti₂AlN(21), WC—Co(5) | 76 | 1,500 | TiN, | W₂CoB₂ | AlN | 66% | 3% | 31% | 0.12 |
| 6 | | | | TiB_{2,} | | | | | | |
| | | | | WC, WB | | | | | | |
| Ex. | cBN(74), TiN(21), WC—Co(5) | 75 | 1,500 | TiN, | W₂CoB₂ | — | 95% | 5% | — | 0.14 |
| 7 | | | | TiB₂, | | | | | | |
| | | | | WC, WB | | | | | | |
| Ex. | cBN(66), Ti₂AlN(20), TiC(4), | 70 | 1,500 | TiN, TiC | W₂CoB₂ | AlN | 64% | 6% | 30% | 0.13 |
| 8 | WC—Co(10) | | | TiB₂, WC, | | AlB₂ | | | | |
| | | | | WB | | | | | | |
| Ex. | cBN(66), TiN(12), TiC(12), | 70 | 1,500 | TiN, TiC, | W₂CoB₂ | — | 91% | 9% | — | 0.15 |
| 9 | WC—Co(10) | | | TiB₂, WC, | | | | | | |
| | | | | WB | | | | | | |
| Ex. | cBN(65), TaN(10), | 65 | 1,500 | TiN, TaN, | W₂CoB₂ | AlN, | 64% | 8% | 28% | 0.16 |
| 10 | TiN(10),Al(5), | | | TiB₂, WC | | AlB₂ | | | | |
| | WC—Co(10) | | | | | | | | | |
| Ex. | cBN(65), TaN(10), TiN(20), | 65 | 1,500 | TiN, TaN, | W₂CoB₂ | — | 95% | 5% | — | 0.20 |
| 11 | WC—Co(5) | | | TiB₂, WC | | | | | | |
| Ex. | cBN(64), Ti₂AlN(32), WC—Co(4) | 64 | 1,500 | TiN, TiB₂ | W₂CoB₂ | AlN | 65% | 4% | 31% | 0.15 |
| 12 | | | | | | | | | | |
| Ex. | cBN(54), TiN(15), TiC(20), | 50 | 1,500 | TiC, TiN, | W₂CoB₂ | AlN, | 63% | 5% | 32% | 0.21 |
| 13 | Al(8), WC—Co(5) | | | TiB₂, W₂B | | AlB₂ | | | | |
| Ex. | cBN(54), TiN(20), TiC(23), | 50 | 1,500 | TiC, TiN, | W₂CoB₂ | — | 98% | 2% | — | 0.25 |
| 14 | WC—Co(5) | | | TiB₂, W₂B | | | | | | |
| Ex. | cBN(54), Ti₂AlN(43), WC—Co(3) | 50 | 1,500 | TiN, | W₂CoB₂ | AlN | 66% | 2% | 32% | 0.22 |
| 15 | | | | TiB₂, WC | | | | | | |
| | | | | W₂B | | | | | | |
| Comp. | cBN(90), Al(5), WC—Co(5) | 90 | 1,500 | — | WCoB, | AlN, | — | 50% | 50% | Life end |
| Ex. 1 | | | | | W₂C₂₁B₆ | AlB₂ | | | | 6,000 m |
| Comp. | cBN(84), TiN(5), TiC(5), Al(6) | 90 | 1,200 | TiN, | — | AlN, | 32% | — | 68% | Life end |
| Ex. 2 | | | | TiC, | | AlB₂ | | | | 2,000 m |
| | | | | TiB₂ | | | | | | |
| Comp. | cBN(80), TiC(10), Al(10) | 85 | 1,200 | TiC, | — | AlN, | 23% | — | 77% | Life end |
| Ex. 3 | | | | TiB₂ | | AlB₂ | | | | 2,500 m |
| Comp. | cBN(74), TiAl₃(21), WC(5) | 80 | 1,200 | TiN, | — | AlN, | 34% | — | 66% | Life end |
| Ex. 4 | | | | TiB₂, WC | | AlB₂ | | | | 2,000 m |
| Comp. | cBN(61), TiC(18), Al(16), | 70 | 1,200 | TiC, | — | AlN, | 26% | — | 74% | Life end |
| Ex. 5 | WC(5) | | | TiB₂, WC | | AlB₂ | | | | 2,000 m |
| Comp. | cBN(58), TiCN(22), Al(15), | 70 | 1,200 | TiCN, | — | AlN, | 30% | — | 70% | Life end |
| Ex. 6 | WC(5) | | | TiB₂, WC | | AlB₂ | | | | 3,000 m |
| Comp. | cBN(45), TiN(42), Al(13) | 60 | 1,200 | TiN, | — | AlN, | 45% | — | 55% | Life end |
| Ex. 7 | | | | TiB₂ | | AlB₂ | | | | 2,500 m |
| Comp. | cBN(35), TiC(48), Al(13), | 50 | 1,200 | TiC, | — | AlN, | 51% | — | 49% | Life end |
| Ex. 8 | Wc(5) | | | TiB₂ | | AlB₂ | | | | 3,000 m |

(1) Group IVa, Va, VIa compounds
(2) Group IVa, Va, VIa - Group VIII borides
(3) Al compounds

The sintered product was cut into tips (13 mm×13 mm) by means of a wire electric discharge machine, and each tip was processed into a cutting tool of the shape specified by JIS/SNMN120308.

The tool was evaluated in terms of wear resistance and the anti-falling property of cBN grains (i.e., chipping resistance of cutting edge) through a dry high-speed cutting (turning) test. The cutting test was performed under the following conditions: material to be cut=FC 250, cutting speed=650 m/min; depth of cut=2.0 mm; feed per revolution=0.3 mm/revolution, and cutting length=10,000 m.

After completion of the cutting test, the width of flank wear of the tested sample (cutting edge) was measured. In addition, a portion of the sample was polished, and the polished surface was analyzed by means of an X-ray diffractometer, an electron probe microanalyzer, and a graphic image analyzer, to thereby determine the cBN content and the crystal composition of the binder. Table 1 shows the results. When the width of flank wear of the cutting edge reached 0.3 mm, end of tool life (service life) was judged to have been reached, and the test was terminated.

As is clear from Table 1, the sintered product of the present invention exhibits a small width of flank wear as compared with similar conventional sintered products, and high wear resistance and anti-falling property of cBN grains can be attained.

### Industrial Applicability

The sintered cBN product of the present invention attains excellent wear resistance and anti-falling property of cBN grains as compared with similar conventional sintered products, even when the product is used under severe working conditions. Particularly, when the sintered product is used as a cutting tip, there can be attained excellent cutting performance; e.g., reduced width of flank wear, as compared with conventional cBN sintered product tips. Thus, the frequency of replace of tips during cutting or turning can be reduced, to thereby attain high productivity.

1. A sintered product containing cubic boron nitride and a binder, characterized in that the binder contains at least one species selected from among nitrides, carbides, carbide nitrides, and borides of a Group IVa, Group Va, or Group VIa element; and a boride containing a Group VIII element, and a Group IVa, Group Va, or Group VIa element.

2. A sintered product containing cubic boron nitride and a binder, characterized in that the binder contains at least one species selected from among nitrides, carbides, carbide nitrides, and borides of a Group IVa, Group Va, or Group VIa element; a boride containing a Group VIII element, and a Group IVa, Group Va, or Group VIa element; and an Al compound.

3. A sintered product as described in claim 1 or 2, wherein the nitrides, carbides, carbide nitrides, and borides of a Group IVa, Group Va, or Group VIa element are TiN, TiC, TiCₓN₁₋ₓ (0<x<1), TiB₂, WC, WB, and W₂B.

4. A sintered product as described in any one of claim 1 to 3, wherein the boride containing a Group VIII element, and a Group IVa, Group Va, or Group VIa element is WCOB, W₂Co21B₆, W₃CoB₃, or W₂CoB₂.

5. A sintered product as described in any one of claim 2 to 4, wherein the Al compound is AlN or AlB₂.

6. A sintered product as described in any one of claim 1 to 3, wherein the sintered product contains cubic boron nitride in an amount falling within a range of 50-95 area % and the binder contains species selected from among nitrides, carbides, carbide nitrides, and borides of a Group IVa, Group Va, or Group VIa element in a total amount falling within a range of 58-98 area % based on the entirety of the binder, and the boride containing a Group VIII element, and a Group IVa, Group Va, or Group VIa element in an amount falling within a range of 2-42 area %.

7. A sintered product as described in claim 2 or 3, wherein the sintered product contains cubic boron nitride in an amount falling within a range of 50-95 area %, and the binder contains species selected from among nitrides, carbides, carbide nitrides, and borides of a Group IVa, Group Va, or Group VIa element in a total amount falling within a range of 36-78 area % based on the entirety of the binder; the boride containing a Group VIII element, and a Group IVa, Group Va, or Group VIa element in an amount falling within a range of 2-43 area %; and the Al compound in an amount falling within a range of 16-33 area %.

8. A cutting tool employing a sintered product described in any one of claim 1 to 3.
